(19) United States
(12) Patent Application Publication
(10) Pub. No.: US 2002/0048260 A1
(43) Pub. Date: Apr. 25, 2002

(54) CIRCUIT EMULATION COMMUNICATION METHOD AND DEVICE

(76) Inventor: EIJI IIDAKA, KANAGAWA (JP)

Correspondence Address: HELEGOTT & KARAS, 60TH FLOOR, EMPIRE STATE BUILDING, NEW YORK, NY, 101180110

(21) Appl. No.: 09/038,574

(22) Filed: Mar. 11, 1998

(30) Foreign Application Priority Data
Oct. 8, 1997 (JP) 9-275856

(51) Int. Cl. H04L 1/00

(52) U.S. Cl. 370/242; 370/252

(57) ABSTRACT

A circuit emulation communication method includes the steps of: (a) converting user data received from a non-ATM medium into ATM cells, and transmitting the ATM cells to an ATM network; (b) converting ATM cells received from the ATM network into user data, and transmitting the user data to the non-ATM medium; (c) analyzing the user data received from the non-ATM medium in order to determine whether the user data coincides with non-communication pattern, and stopping a process of converting the user data into ATM cells carried out at step (a); and (d) generating non-communication pattern when any ATM cell is not received from the ATM network and sending the non-communication pattern to the non-ATM medium.

### BACKGROUND OF THE INVENTION

1. Field of the Invention

The present invention relates to a circuit emulation communication method for emulating a synchronous transfer communication between non-ATM communication devices or non-ATM networks by an ATM network which operates in an asynchronous transfer mode (ATM). Further, the present invention is concerned with a transmit device and a receive device having a circuit emulation communication as described above.

2. Description of the Related Art.

FIGS. 1A, 1B and 1C are diagrams of ATM communication devices having a conventional circuit emulation communication function. FIG. 1A shows non-ATM communication devices 52 and 53 that are mutually connected via a non-ATM network 51, which is an existing circuit network of a synchronous transfer communication. A continuous data transfer can be carried out at a fixed bit rate between the non-ATM communication devices 52 and 53 via the non-ATM network 51.

The circuit emulation communication is directed to realizing, in the ATM network, a transfer function equivalent to the transfer in the non-ATM network 51. As shown in FIG. 1B, ATM communication devices 55 and 56 accommodated in an ATM network 54 are respectively equipped with the circuit emulation communication function. The non-ATM communication devices 52 and 53 are mutually connected via the ATM communication devices 55 and 56. Hence, the non-ATM communication devices 52 and 53 can transfer continuous data in the synchronous transfer communication. The ATM communication devices 55 and 56 equipped with the circuit emulation communication function assemble ATM cells as user cells and transmit the ATM cells to the ATM network 54. Further, the ATM communication devices 55 and 56 disassemble the received ATM cells to thereby reproduce the original continuous data. In the above manner, the non-ATM communication devices 52 and 53 can provide, via the ATM network 54, services equivalent to those provided via the non-ATM network 51 shown in FIG. 1A.

Referring to FIG. 1C, non-ATM networks or non-ATM interlaces can mutually be connected via the ATM communication devices 55 and 56 equipped with the circuit emulation communication function. Hence, the non-ATM networks or the non-ATM communication devices can provide, via the ATM network, services equivalent to those provided via the non-ATM network 51 shown in FIG. 1A.

If the ATM communication devices 55 and 56 equipped with the circuit emulation communication function are applied to an ATM-LAN (LAN: Local Area Network) or a closed (private) network employing leased or dedicated lines, it is not necessary to calculate the line using fees for each cell on the basis of the data-amount-based accounting system. Further, it is relatively easy to extend transmission lines. In contrast, in a public network requires, the number of cells communicated is counted for the fee calculation.

If the non-ATM communication devices 52 and 53 are asynchronous transfer communication devices such as data transmission devices, only necessary data is transferred at a necessary time, so that occurrence of a wasteful fee can be avoided even when the cells are transferred via the public network.

If circuit switching services such as speech communication using telephone communication devices such as telephone sets are provided in the system shown in FIG. 1B in the case where the ATM network 54 is assumed as a public ATM network, it is required to continuously transfer a given number of cells between the ATM communication devices 55 and 56 equipped with the circuit emulation communication function even if no speech communication takes place. Hence, it is necessary to maintain the communication path between the telephone communication devices even if no speech communication takes place. As long as the communication path is maintained, the fee is calculated. This is a problem to be solved.

If a fault occurs in a line circuit in the non-ATM communication device or non-ATM network in the conventional circuit emulation communication, information concerning the line fault is transmitted as user data. Hence, even the notification of the line fault is charged. Further, since the notification of the line fault is transmitted using the user data transmission band of the public ATM network, the remaining band available by the users is limited and required services may be executed.

### SUMMARY OF THE INVENTION

It is a general object of the present invention to provide a circuit emulation communication method and device in which the above disadvantages are eliminated.

A more specific object of the present invention is to realize a circuit emulation communication method and device in which wasteful fee accounting can be avoided and the user data transmission band can be efficiently utilized.

The above objects of the present invention are achieved by a circuit emulation communication method comprising the steps of: (a) converting user data received from a non-ATM medium into ATM cells, and transmitting the ATM cells to an ATM network; (b) converting ATM cells received from the ATM network into user data, and transmitting the user data to the non-ATM medium; (c) analyzing the user data received from the non-ATM medium in order to determine whether the user data coincides with non-communication pattern, and stopping a process of converting the user data into ATM cells carried out at step (a); and (d) generating non-communication pattern when any ATM cell is not received from the ATM network and sending the non-communication pattern to the non-ATM medium.

The circuit emulation communication method may further comprise the steps of: (e) generating a fault notification cell when detecting a fault occurring in the non-ATM medium and sending the fault notification cell to the ATM network; and (f) sending an alarm signal to the non-ATM medium when receiving a fault notification cell from the ATM network.

The above objects of the present invention are also achieved by a circuit emulation communication device comprising: a data receive part which receives user data from a non-ATM medium; a cell assemble part which converts the user data into ATM cells; a cell transmit part which sends the ATM cells to an ATM network; a data analyzing part which analyzes the user data received from the non-ATM medium; a non-communication pattern memory part which stores a non-communication pattern which is sent when no user data is received; and a control part which stops the cell assemble part when the user data analyzed by the data analyzing part coincides with the non-communication pattern stored in the non-communication pattern memory part.

The circuit emulation communication device may further comprise: a fault detection part which detects a fault in the non-ATM medium; and a fault notification cell generating part generating a fault notification cell, the control part controlling the fault notification cell generating part to generate the fault notification cell when the fault detection part detects the fault and controlling the fault detection cell to be sent to the ATM network via the cell transmit part.

The above objects of the present invention are also achieved by a circuit emulation communication device comprising: a cell receive part which receives ATM cells via an ATM network; a disassemble part which converts the ATM cells into user data; a transmit part which transmits the user data to a non-ATM medium; a non-communication pattern memory part which stores a non-communication pattern which is sent when no user data is received; and a control part which reads the non-communication pattern from the non-communication pattern memory and sends the non-communication pattern to the ATM medium.

The circuit emulation communication device may further comprise: a fault detection part which detects a fault in the non-ATM medium; and a fault notification cell generating part generating a fault notification cell, the control part controlling the fault notification cell generating part to generate the fault notification cell when the fault detection part detects the fault and controlling the fault detection cell to be sent to the ATM network via the cell transmit part.

The above objects of the present invention are also achieved by a circuit emulation communication device comprising: a first data receive part which receives user data from a non-ATM medium; a cell assemble part which converts the user data into ATM cells; a first cell transmit part which sends the ATM cells to an ATM network; a data analyzing part which analyzes the user data received from the non-ATM medium; a non-communication pattern memory part which stores a non-communication pattern which is sent when no user data is received; a second cell receive part which receives ATM cells via the ATM network; a disassemble part which converts the ATM cells into user data; a second transmit part which transmits the user data to the non-ATM medium; a control part which stops the cell assemble part when the user data analyzed by the data analyzing part coincides with the non-communication pattern stored in the non-communication pattern memory part and which reads the non-communication pattern from the non-communication pattern memory and sends the non-communication pattern to the ATM medium.

### BRIEF DESCRIPTION OF THE DRAWINGS

Other objects, features and advantages of the present invention will become more apparent from the following detailed description when read in conjunction with the accompanying drawings, in which:

FIGS. 1A, 1B and 1C are block diagrams of ATM communication devices having a conventional circuit emulation communication;

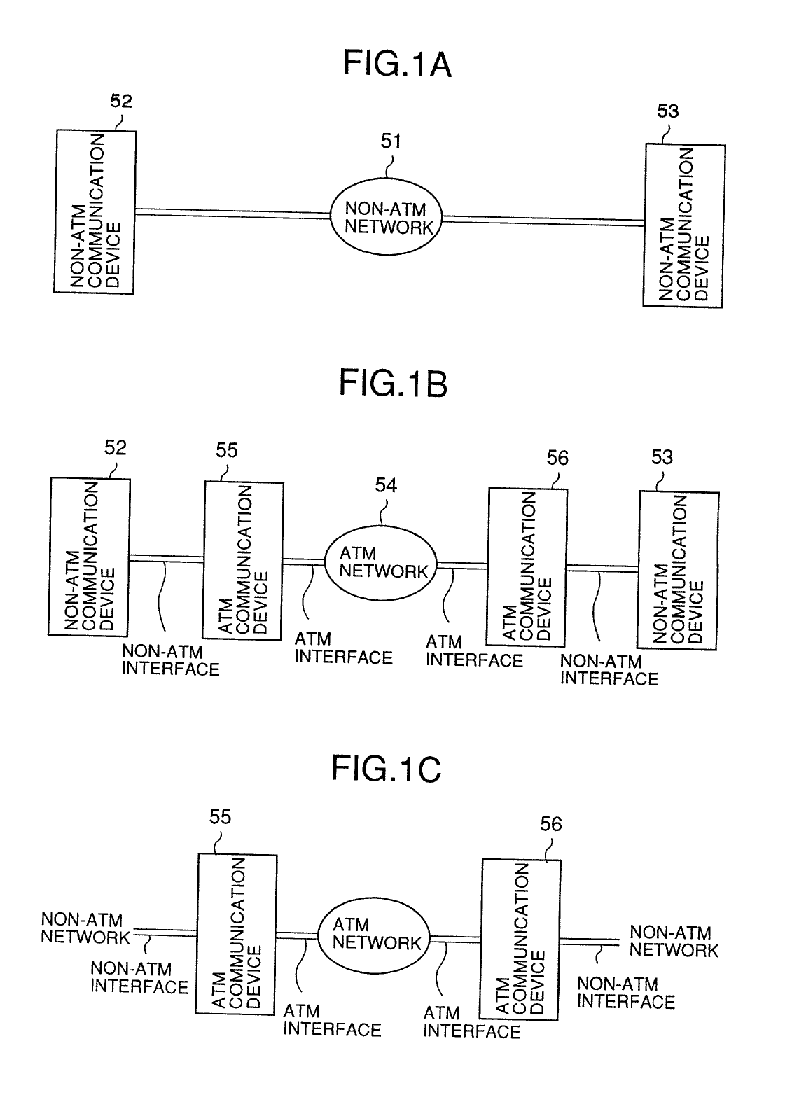

FIG. 2 is a block diagram of a circuit emulation communication device according to a first embodiment of the present invention;

FIG. 3 is a diagram of a DS1 transmission frame format;

FIG. 4 is a block diagram of a circuit emulation communication device according to a second embodiment of the present invention;

FIG. 5 is a flowchart of operations of the first and second embodiments of the present invention which are carried out at the circuit emulation communication device located on the transmit side; and

FIG. 6 is a flowchart of operations of the first and second embodiments of the present invention which are carried out at the circuit emulation communication device located on the receive side.

### DESCRIPTION OF THE PREFERRED EMBODIMENTS

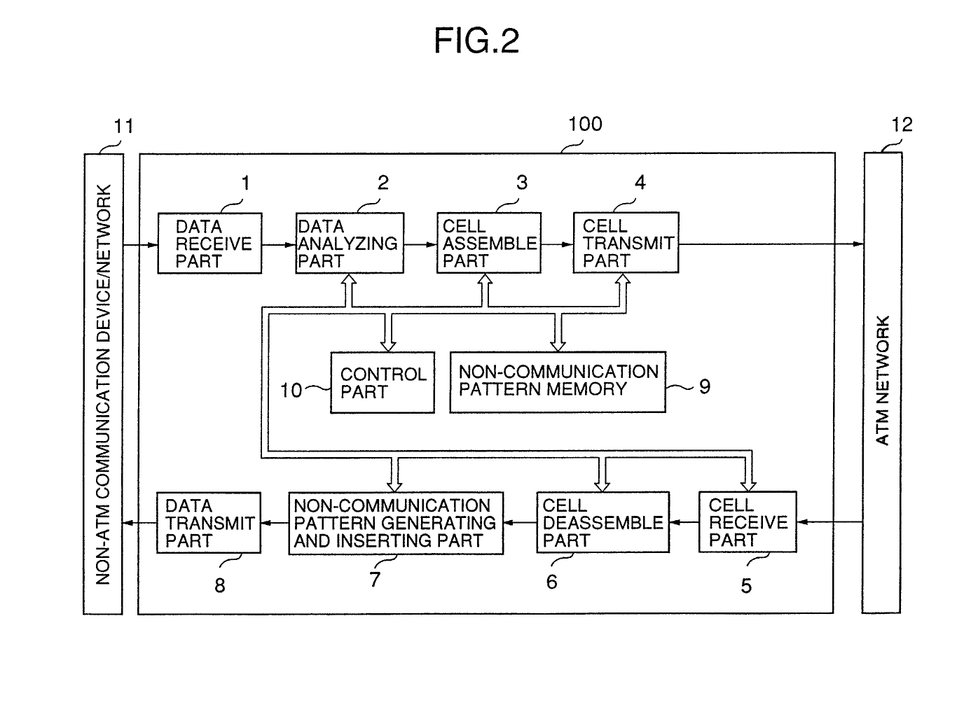

FIG. 2 is a block diagram of a circuit emulation communication device according to a first embodiment of the present invention. A circuit emulation communication device 100 shown in FIG. 2 includes a data receive part 1, a data analyzing part 2, a cell assemble part 3, a cell transmit part 4, a cell receive part 5, a cell disassemble part 6, a non-communication pattern generating and inserting part 7, a data transmit part 8, a non-communication pattern memory part 9 and a control part 10. The circuit emulation communication device 100 is connected to a non-ATM communication device/network 11, and an ATM network, as shown in FIG. 2.

The data receive part 1 receives data from a non-ATM communication device/network 11. The data analyzing part 2 analyzes the received non-ATM data. The cell assemble part 3 converts the received non-ATM data into ATM cells. The cell transmit part 4 sends the ATM cells to the ATM network 12. The cell receive part 5 receives ATM cells from the ATM network 12. The cell disassemble part 6 converts the received ATM cells to non-ATM cell data. The non-communication pattern generating and inserting part 7 generates a non-communication pattern using the database of a non-communication pattern stored in the non-communication pattern memory 9 into non-ATM data. The data transmit part 8 sends the non-ATM data to the non-ATM communication device/network 11. The non-communication pattern memory part 9 stores the database of the non-communication pattern. The control part 10 controls the parts of the ATM communication device having the circuit emulation communication function.

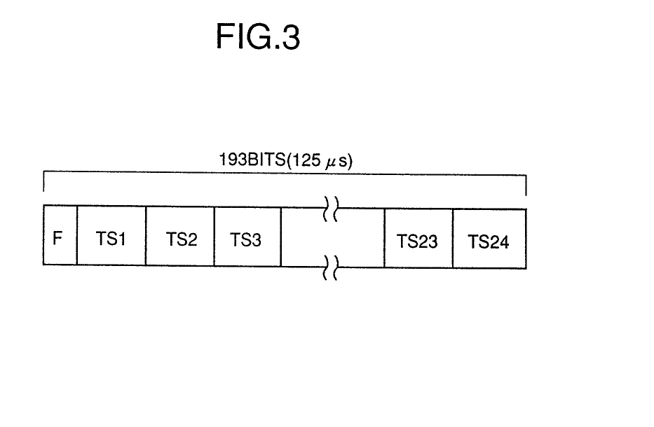

A description will now be given of a network of a circuit line which transfers a transmission frame of DS1 (1.544 Mbps), such a network being an example of the non-ATM network to be emulated. FIG. 3 shows a format of the transmission frame of the DS1, which is made up of a one-bit flag F for framing (frame synchronization), and 24 time slots TS1 through TS24 for transmitting user data. Each of the time slots TS1 through TS24 has one octet (eight bits). The transmission frame of the DS1 has 193 bits in total.

When the transmission frame of the DS1 (1.544 Mbps) is sent via the ATM network, the transmission sequence depends on whether the transfer mode defined in the ATM adaptation layer protocol (AAL) is an unstructured mode or a structured mode, or whether the clock between communication devices is synchronized in the end-to-end formation in the ATM network.

The first case will now be described where the transfer mode is the unstructured mode and the clock between the communication devices is synchronized in the end-to-end formation. In the unstructured mode, it is necessary to transparently transmit, in the ATM network, data received from the non-ATM communication device or non-ATM network. The synchronization of the clock between the communication devices is ensured in the end-to-end formation. Hence, all of the 193 bits in the transmission frame of the DS1 are cell-assembled and are then transmitted via the ATM network. If the non-communication pattern is detected as will be described below, sending of ATM cells is stopped.

The non-communication pattern in each channel of the transmission frame of the DS1 is, for example, “11111111”. In this case, a pattern in which all of the 192 bits for the time slots TS1-TS24 are “1” is stored in the non-communication pattern memory part 9 as a database of the non-communication pattern. The database of the non-communication pattern can arbitrarily be modified by an external operation.

The data analyzing part 2 analyzes all the data bits equal to 24 channels of the DS1 transmission frame received by the data receive part 1. If the data analyzing part 2 finds that the received bits coincide with the non-communication pattern, the part discards all the 193 bits including the frame bit F. Hence, the cell having the non-communication pattern is not cell-assembled and is prevented from being transmitted by the cell transmit part 4.

Further, the cell receive part 5 receives ATM cells from the ATM network 12. The cell disassemble part 6 reproduces the DS1 transmission from the received cells. In the case where the ATM communication device on the transmit side discards the transmission frame having the same pattern as the non-communication pattern, the cell receive part 5 receives only the cell for synchronization. Hence, the cell disassemble part 6 cannot retrieve the DS1 transmission frame.

Hence, the non-ATM pattern generating and inserting part 7 generates a non-communication pattern from the non-communication pattern registered in the non-communication pattern memory part 9, and inserts the generated pattern into the non-ATM user data. Hence, it is possible to completely retrieve, in the ATM communication device on the receive side, the DS1 transmission frame which is received by the ATM communication device on the transmit side and is supplied from the non-ATM communication device/network 11.

A description will now be given of the second case where the transfer mode is the unstructured mode and the clock between the communication devices is not synchronized in the end-to-end formation. Since the clock is asynchronous between the ATM network 12 and the non-ATM communication device/network 11, the clock is pulled in synchronization between the communication devices in the end-to-end formation by a synchronous residual time step (SRTS) method or an adaptive lock method recommended by the IT-T or ATM Forum. In this case, the cell having the same pattern as the non-communication pattern is discarded and is not transmitted by the ATM communication device located on the transmit side, while the DS1 communication frame having the non-communication pattern can be retrieved by the ATM communication device located on the receive side. as in the first case described before. A means for pulling the clock in synchronization between the end-to-end communication devices is not directly related to the present invention, and a detailed description thereof will not be given here.

The third case will be described where the transfer mode is the structured mode. In this mode, the synchronization of the clock between the communication devices in the end-to-end formation is ensured. The ATM communication device extracts data having a band specified beforehand from the data of the DS1 transmission frame received via the non-ATM communication device/network 11, and assembles the ATM cells. That is, one of the time slots TS1-TS24 of the DS1 transmission frame is specified and converted into the cells, which are transferred via the ATM network.

In the structured mode, a pointer indicating the boundary of structured data is inserted every eight cells in the ATM adaptation layer (AAL). Hence, if the data analyzing part 2 of the ATM communication device on the transmit side detects the non-communication pattern within the band of the received data specified beforehand and obtained from the non-ATM communication device/network 11, the data analyzing part 2 stops the ATM communication device to transmit the ATM cells to the ATM network 12.

The ATM communication device on the receive side cannot receive the ATM cells in the corresponding channel (communication path). Thus, the non-communication pattern generating and inserting part 7 of the above ATM communication device generates, based on the pointer information in the cell received just before, the transmission frame having the non-communication pattern, and sends the transmission frame thus generated to the non-ATM communication device/network 11.

In the structured mode, the non-communication pattern is analyzed and processed every slot. In contrast, the unstructured mode analyzes and processes the non-communication pattern of all the 24 time slots. In this regard, the structured mode differs from the unstructured mode. The other things of the structured mode are the same as those of the unstructured mode.

According to the first embodiment of the present invention, when the circuit emulation communication via the public ATM network takes place, the cells are prevented, in the ATM communication device on the transmit side, from being transmitted in the non-communication state detected by using the non-communication pattern. In the ATM communication device on the receive side, the non-communication pattern is generated and sent when the cell transfer is stopped. Hence, the transparency of communications can be ensured and the cells are not sent at the time of non-communication. Hence, only valid cells can be sent.

In the first embodiment of the present invention, when the non-communication pattern is detected in the ATM communication device on the transmit side, the sending of ATM cells is stopped. If a fault occurs in a line circuit of the network, the ATM communication device will receive no ATM cells as in the case where the non-communication pattern is detected in the ATM communication device on the transmit side. Hence, the ATM communication device on the receive side cannot determine whether the fault occurs or the non-communication state occurs on the transmit side.

With the above in mind, a second embodiment of the present invention is made and is capable of determining whether a fault occurs or the non-communication state occurs on the transmit side by using a fault notification cell, which is sent to the ATM communication device on the receive side when the ATM communication derive on the transmit side detects a fault.

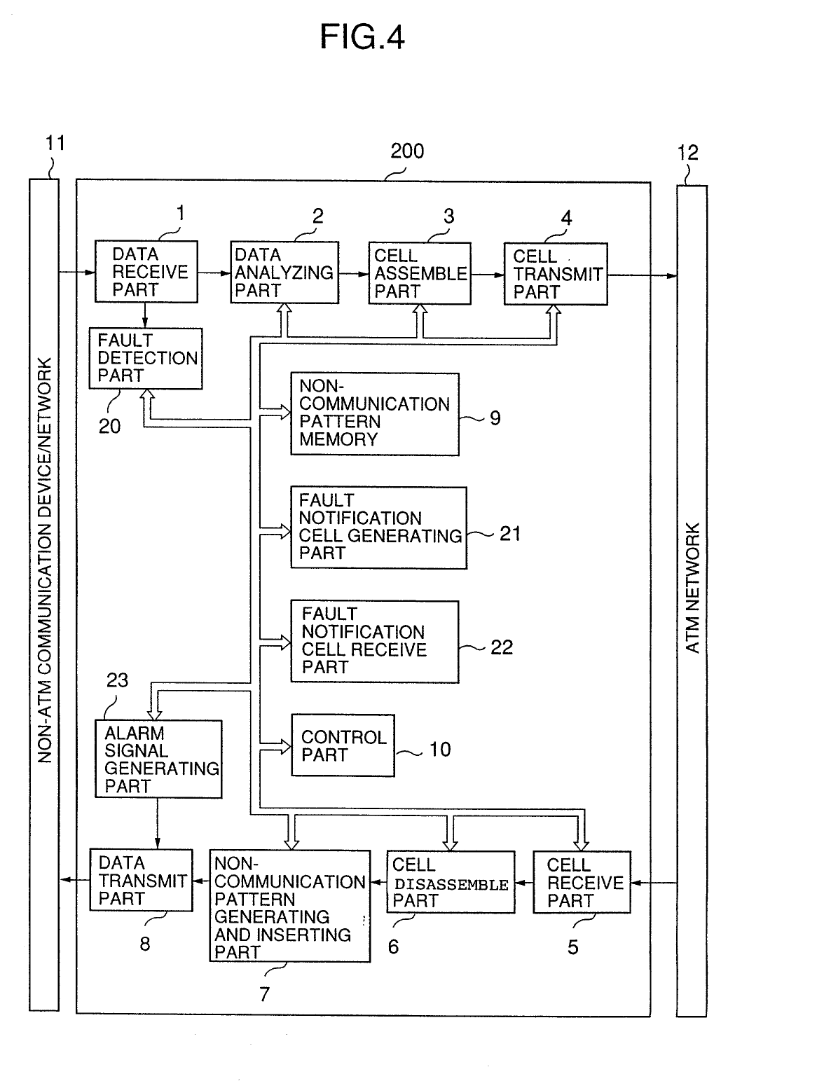

FIG. 4 is a block diagram of a circuit emulation communication device according to the second embodiment of the present invention. In FIG. 4, parts that are the same as those of the first embodiment thereof are given the same reference numbers. A circuit emulation communication device 200 shown in FIG. 4 includes a fault detection part 20, a fault notification cell generating part 21, a fault notification cell receive part 22, and an alarm signal generating part 23. The fault detection part 20 detects a fault which occurs in the non-ATM network 11. The fault notification cell generating part 21 notifies the other-side ATM communication device of the detected fault via the ATM network 12. The fault notification cell receive part 22 receives the fault notification cell via the ATM network 12. The alarm signal generating part 23 generates an alarm signal to the non-ATM network 11 on the basis of the received fault notification cell.

If a fault of the DS1 transmission frame is detected by the fault detection part 20 of the ATM communication device on the transmit side, the fault notification cell generating part 21 generates the fault notification cell, which is then sent, by the cell transmit part 4, to the ATM communication device on the receive side via a path over which user data is transmitted.

The fault notification cell receive part 22 of the ATM transmission communication device on the receive side receives the fault notification cell via the cell disassemble part 6, and then the alarm signal generating part 23 generates the alarm signal, which is sent to the non-ATM network 11 via the data transmit part 8.

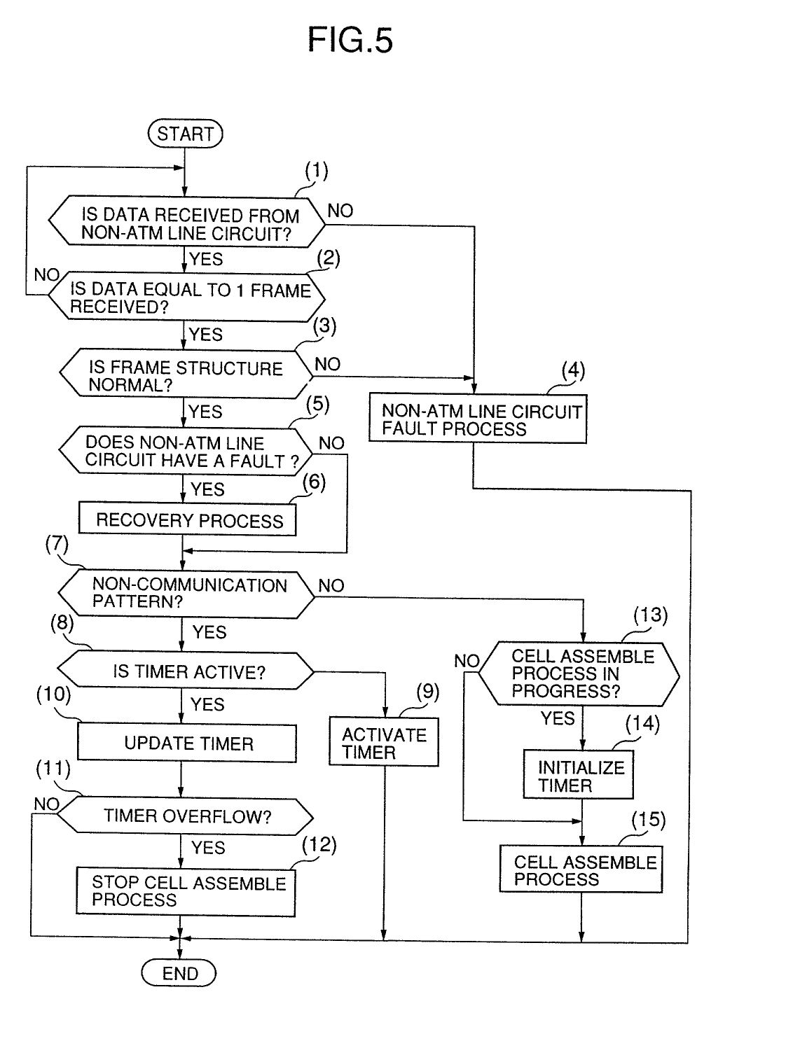

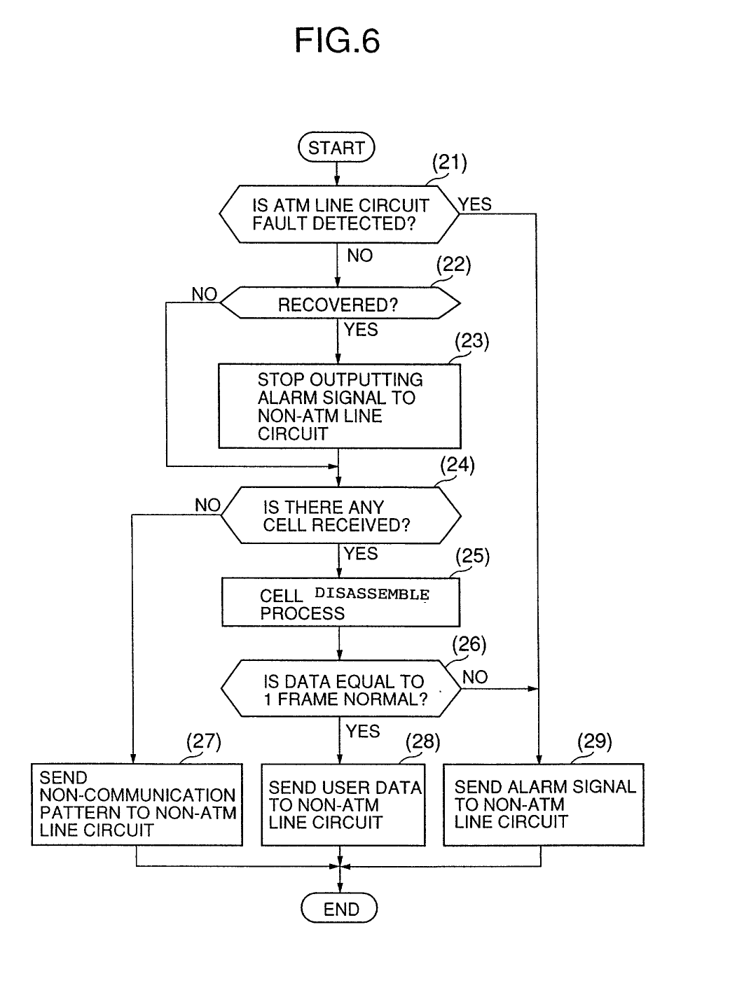

FIG. 5 is a flowchart of the operation of the circuit emulation communication device on the transmit side according to the first and second embodiments of the present invention. FIG. 6 is a flowchart of the operation of the circuit emulation communication device on the receive side according to the first and second embodiments of the present invention. First, a description will be given, with reference to FIGS. 2, 4 and 5, of the operations of the circuit emulation communication devices located on the transmit side according to the first and second embodiments of the present invention. Second, a description will be given, with reference to FIGS. 2, 4 and 6, of the operations of the circuit emulation communication devices according to the first and second embodiments of the present invention located on the receive side. In FIGS. 5 and 6, steps related to the fault detection carried out in the second embodiment of the present invention are not executed in the operation of the first embodiment thereof.

Referring to FIGS. 2, 4 and 5, at steps (1), (2) and (3), it is determined, by the fault detection part 20 and the control part 10, whether data equal to one frame has duly been received from a non-ATM line circuit to which the non-ATM communication device/network 11. If no data is received from the non-ATM line circuit or the frame structure is defective, it is determined that a fault has occurred, and a non-ATM line circuit fault process is executed at step (4).

In the non-ATM line circuit fault process executed at step (4), the fault notification cell is sent to the other-side ATM communication device by the fault notification cell generating part 21, the cell transmit part 4 and the control part 10. The fault notification cell may be a cell similar to an OAM cell different from the user data cell. The fault notification cell can be transmitted at intervals longer than intervals at which the cell is transmitted in the normal communication state. The intervals at which the fault notification cell is transmitted can be varied on the basis of the fault recovery state.

When it is determined, at steps (1), (2) and (3), that data has duly been received from the non-ATM line circuit, the control part 10 execute step (5) at which it is determined whether the non-ATM line circuit has a fault. When the answer of step (5) is YES, a non-ATM line circuit fault recovery process is executed under the control of the control part 10.

At step (7), it is determined, by the data analysis part 2, the non-communication pattern memory part 9 and the control part 10, whether the received data coincides with the non-communication pattern. At steps (8), (9), (10) and (11), it is determined by the control part 10 whether the non-communication pattern continues over a given time set in a non-communication detection timer. If it is determined that the non-communication pattern continues over the given time, the control part 10 stops the cell assembly process at step (12).

At step (7), if it is determined that the data received from the non-ATM line circuit is not the non-communication pattern, the control part 10 initializes the non-communication detection timer if the cell assembly process is stopped. Then, the control part 10 executes step (15) at which cells are assembled from the received data. That is, the received non-ATM data is converted into ATM cells, which are then sent to the ATM network 12. If the answer of step (13) is NO, step (15) is executed.

Referring to FIG. 6, a description will be given of the operation of the receive-side circuit emulation communication device according to the first and second embodiments of the present invention. At step (21), the fault notification cell receive part 22 receives the fault notification cell via the cell receive part 5 and the control part 10 detects the line circuit fault information from the ATM network 12, the alarm signal is sent at step (29) to the non-ATM line circuit under the control of the alarm signal generating part 23 and the data transmit part 8.

If the line circuit fault information from the ATM network 12 is not detected at step (21), the control part 10 determines, at step (22), whether the fault of the ATM line circuit has been removed. If the answer is YES, the control part 10 stops sending the alarm signal to the non-ATM line circuit at step (23), and proceeds to step (24). If the answer of step (22) is NO, the process proceeds to step (24). At step (24), the control part 10 determines if there is any cell received by the cell receive part 5. If the answer is NO, the non-communication pattern is sent to the non-ATM line circuit under the control of the control part 10 in which the non-communication pattern is read from the non-communication pattern memory part 9 and is inserted into data by the non-communication pattern generating and inserting part 7. Then, the non-communication pattern is sent to the non-ATM line circuit via the data transmit part 8.

If it is determined at step (24) that there is a cell received by the cell receive part 5, the cell disassemble part 6 performs the cell disassemble process at step (25). The control part 10 determines, at step (26), whether data equal to one frame is normal. If the answer is affirmative, the data is sent to the non-ATM line circuit via the data transmit part 8 at step (28). If the answer of step (26) is negative, step (29) is executed.

In the first and second embodiments of the present invention, the non-communication pattern memory part 9 may store information necessary to generate the non-communication pattern or the non-communication pattern itself. In the latter case, the non-communication pattern generating and inserting part 7 merely inserts the non-communication pattern to the non-ATM data.

The present invention is not limited to the specifically disclosed embodiments, and variations and modifications may be made without departing from the scope of the present invention.

What is claimed is:

1. A circuit emulation communication method comprising the steps of:
(a) converting user data received from a non-ATM medium into ATM cells, and transmitting the ATM cells to an ATM network;
(b) converting ATM cells received from the ATM network into user data, and transmitting the user data to the non-ATM medium;
(c) analyzing the user data received from the non-ATM medium in order to determine whether the user data coincides with non-communication pattern, and stopping a process of converting the user data into ATM cells carried out at step (a); and
(d) generating non-communication pattern when any ATM cell is not received from the ATM network and sending the non-communication pattern to the non-ATM medium.

2. The circuit emulation communication method as claimed in claim 1, further comprising the steps of:
(e) generating a fault notification cell when detecting a fault occurring in the non-ATM medium and sending the fault notification cell to the ATM network; and
(f) sending an alarm signal to the non-ATM medium when receiving a fault notification cell from the ATM network.

3. A circuit emulation communication device comprising:
a data receive part which receives user data from a non-ATM medium;
a cell assemble part which converts the user data into ATM cells;
a cell transmit part which sends the ATM cells to an ATM network;
a data analyzing part which analyzes the user data received from the non-ATM medium;
a non-communication pattern memory part which stores a non-communication pattern which is sent when no user data is received; and
a control part which stops the cell assemble part when the user data analyzed by the data analyzing part coincides with the non-communication pattern stored in the non-communication pattern memory part.

4. The circuit emulation communication device as claimed in claim 3, further comprising:
a fault detection part which detects a fault in the non-ATM medium; and
a fault notification cell generating part generating a fault notification cell,
the control part controlling the fault notification cell generating part to generate the fault notification cell when the fault detection part detects the fault and controlling the fault detection cell to be sent to the ATM network via the cell transmit part.

5. A circuit emulation communication device comprising:
a cell receive part which receives ATM cells via an ATM network;
a disassemble part which converts the ATM cells into user data;
a transmit part which transmits the user data to a non-ATM medium;
a non-communication pattern memory part which stores a non-communication pattern which is sent when no user data is received; and
a control part which reads the non-communication pattern from the non-communication pattern memory and sends the non-communication pattern to the ATM medium.

6. The circuit emulation communication device as claimed in claim 5, further comprising:
a fault detection part which detects a fault in the non-ATM medium; and
a fault notification cell generating part generating a fault notification cell,
the control part controlling the fault notification cell generating part to generate the fault notification cell when the fault detection part detects the fault and controlling the fault detection cell to be sent to the ATM network via the cell transmit part.

7. A circuit emulation communication device comprising:
a first data receive part which receives user data from a non-ATM medium;
a cell assemble part which converts the user data into ATM cells;
a first cell transmit part which sends the ATM cells to an ATM network;
a data analyzing part which analyzes the user data received from the non-ATM medium;
a non-communication pattern memory part which stores a non-communication pattern which is sent when no user data is received;
a second cell receive part which receives ATM cells via the ATM network;
a disassemble part which converts the ATM cells into user data;
a second transmit part which transmits the user data to the non-ATM medium;
a control part which stops the cell assemble part when the user data analyzed by the data analyzing part coincides with the non-communication pattern stored in the non-communication pattern memory part and which reads the non-communication pattern from the non-communication pattern memory and sends the non-communication pattern to the ATM medium.
